(19) United States
(12) Patent Application Publication
(10) Pub. No.: US 2011/0270619 A1
(43) Pub. Date: Nov. 3, 2011

(54) System and method of electronic redemption using a mobile device

(76) Inventor: Lucas Lovette, Atlanta, GA (US)

(21) Appl. No.: 12/799,696

(22) Filed: Apr. 30, 2010

(51) Int. Cl. G06Q 30/00; G06K 7/00; G06K 19/06

(52) U.S. Cl. 705/1.1; 235/494; 235/375

(57) ABSTRACT

One key aspect, of this embodiment attempts to provide a better means of redemption, in that a physical action, by the targeted recipient, via the scanning of targeted recipient's smart phone or waving or “wanding” of targeted recipient's RFID device, is necessary.

This application relates to the scanning or reading of the surface of a mobile device, at a physical point of redemption, in order to redeem services, or merchandise, bought or paid for over the Internet.

### CROSS-REFERENCE TO RELATED APPLICATIONS

This application claims the benefit of provisional patent application Ser. No. 61/214,623 filed 2009 Apr. 27, by the present inventor.

### FEDERALLY SPONSORED RESEARCH

Not Applicable

### SEQUENCE LISTING OR PROGRAM

Not Applicable

### BACKGROUND-FIELD

This application relates to the scanning or reading of the surface of a mobile device, at a physical point of redemption, in order to redeem services, or merchandise, bought or paid for over the Internet.

### BACKGROUND-PRIOR ART

The Internet has provided a means to purchase merchandise (and services) online, from a specific website, and automatically having an item physically shipped to a specified shipping address which is called online buying. Many regular or “brick-and-mortar” retailers have added and integrated their product line of merchandise onto a website whereby an individual may purchase the same or similar items coined as “clicks-and-mortars” for themselves or others. Also included are service industries such as airlines and other transportation services, tickets for athletic games, theatres, movies houses, services provided by brokers, insurance agents, lawyers, doctor offices, massage and physical therapists; and any other business defined as a service. The concept of Internet buying has provided a quick, and streamlined, means to searching for, and purchasing consumer merchandise and services.

Online buying has also provided a means to purchase merchandise and services, as gifts, for a targeted recipient. For the past many years, retailers have issued and distributed e-certificates or vouchers, and just recently e-gift cards, purchased by a buyer to the recipient requiring either the targeted recipient, or buyer, or anyone, in possession of a confirmation code, to input the series of alphanumeric symbols, or plain numbers, into the original-issuing retailer's website submission query. As far as the means of redemption the service, or merchandise, the buyer purchased for oneself, or another, may require the individual to be physically at the location to redeem the merchandise or service. So, inputting information into a confirmation code query is useless. A better way is proposed.

### SUMMARY

A method of redeeming a service or merchandise bought over the Internet by the action of a mobile device.

### BRIEF DESCRIPTION OF THE DRAWINGS

FIG. 1 is a flow diagram of an example embodiment of a method of electronic redemption using a mobile device.

FIG. 2 is a flow diagram of an example embodiment of a method of electronic redemption using a mobile device.

FIG. 3 is a flow diagram of an example embodiment of a method of electronic redemption using a mobile device.

FIG. 4 is a flow diagram of an example embodiment of a method of electronic redemption using a mobile device.

FIG. 5 is a flow diagram of an example embodiment of a method of electronic redemption using a mobile device.

FIG. 6 is a flow diagram of an example embodiment of a method of electronic redemption using a mobile device.

FIG. 7 is a system block diagram of an example embodiment of a system of electronic redemption using a mobile device.

FIG. 8 is a system block diagram of an example embodiment of a system of electronic redemption using a mobile device.

FIG. 9 is a system block diagram of an example embodiment of a system of electronic redemption using a mobile device.

FIG. 10 is a system block diagram of an example embodiment of a system of electronic redemption using a mobile device.

FIG. 11 is a system block diagram of an example embodiment of a system of electronic redemption using a mobile device.

### DETAILED DESCRIPTION

As the world expands, travel through air, bus, or train has begun increasingly more popular. Everyone needs to travel; to get to point A to point B, and with the increasing load comes increasing problems such as bottlenecks and maintenance problems. Add to that weather issues, and travel, particularly air, can be a major headache.

However, businesses need to make a profit; and technology usually assists in streamlining processes and cutting cost. So, the need to improve on operations is important. One example is to load passengers, as quickly as possible. To accomplish this, a solution proposed, sometimes called paperless boarding, is an improved redemption process using a passenger's smart phone and scanned, or “read” at a redemption device site.

This embodiment attempts to solve prior-art issues by the redemption of services, or merchandise, bought over the Internet. Then, incorporating the use of an electronic receipt, embedded with a Universal Product Code (either 1 or 2 dimensional), or other graphic symbols, and the redemption of this receipt, by the use of the targeted recipient's smart phone or gift redemption via the physical action of the recipient using a computerized redemption devices (CRU).

The problem this embodiment is also attempting to solve is to provide a better means of providing, distributing and sending electronic gift cards, electronic vouchers, electronic certificates, or other services or merchandise, bought over the Internet, in the form of an electronic receipt, to the targeted recipient's email, and at the same time incorporating a better redemption process, through an action by the targeted recipient during the check-out process.

Previous attempts to provide a solution only focused on the redemption process completed by someone other then the targeted recipient (see Transaction System and Method, patent Ser. No. 11/764,777, Cohn 3 Jan. 2008) and only by a confirmation code. Within the Cohn patent, the targeted recipient primarily receives a drink, not necessarily a gift, e-certificate or voucher, and the redemption process is primarily activated by someone, other than the targeted recipient, primarily via confirmation code, using a tactile keyboard.

One key aspect, of this embodiment attempts to provide a better means of redemption, in that a physical action, by the targeted recipient, via the scanning of targeted recipient's smart phone or waving or “wanding” of targeted recipient's RFID device, is necessary.

Additionally, The Cohn patent didn't address the use of a retailer's Point-of-Sale (P.O.S.) system or the addition of peripheral redemption devices, such as a stand-alone UPC scanners, or Radio Frequency Identification (RFID) receiver pads, directly connected, and tied in with the retailer's computer systems.

This embodiment also addresses sending a gift, or a service, or merchandise bought, from a central website, that has a direct portal to retailer's computer systems, and sending notification to targeted recipient's email inbox, in the form of an e-certificate, voucher or primarily electronic receipt, with printed UPC code or other graphical symbol.

A similar patent (see system and method for distributing mobile gift cards, Ser. No. 12/343,423, Hurst, 2009 Jul. 16), addresses a computer-based system that receives notification of a monetary amount, assigns amount to a mobile gift card, and associates the mobile gift card with a recipient's phone number or another mobile phone number. However, Hurst doesn't address the receiving of an electronic receipt into the targeted recipient's email box or the subsequent physical redemption process by this recipient.

Redemption, as this embodiment attempts to detail, takes place at the Point-of-Sale aisle, or the like, during the checkout process as the targeted recipient performs the redemption of their gift, service or merchandise purchased. In a past art (see Method for Marketing and Redeeming Vouchers for Use in Online Purchases, Messner, 1999), the inventors claim that gift certificates and coupons collectively known as “vouchers” are only for online redemption. Similar to Cohn, the redemption is primarily restricted to online purposes.

Thus, several advantages of one or more aspects is to provide a more streamlined internet gift giving experience, or process, by eliminating the steps involved in purchasing a gift off a retailer's website, or physically from the store, by the buyer and the complete elimination for the necessity to ship, or mail, anything. Other advantages, of one or more aspects, are to provide a means for a quick and easy redemption process that is performed strictly by the recipient.

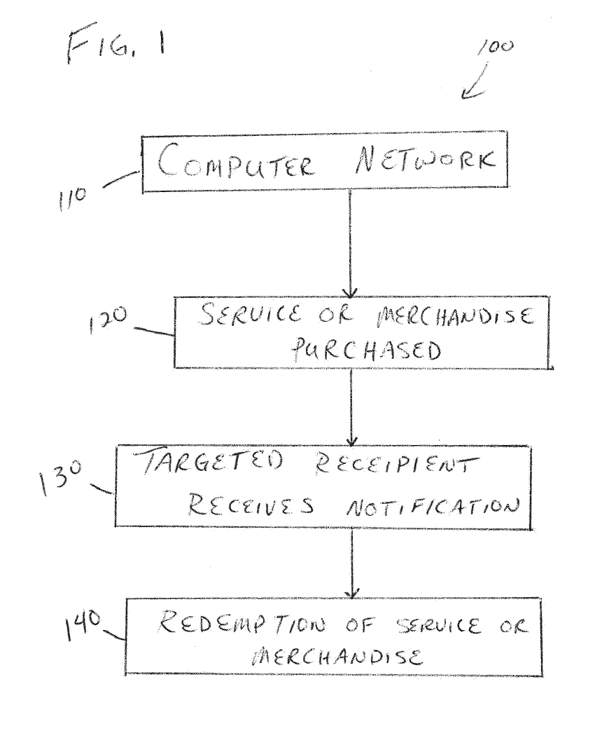

FIG. 1 provides flowchart 100 of an example embodiment of a method of electronic redemption using a mobile device. In block 110, a computer network is accessed. In block 120, a service or merchandise is purchased for a recipient. In block 130, 1 targeted recipient receives notification of the purchase. In block 140, the targeted recipient redeems the service or merchandise.

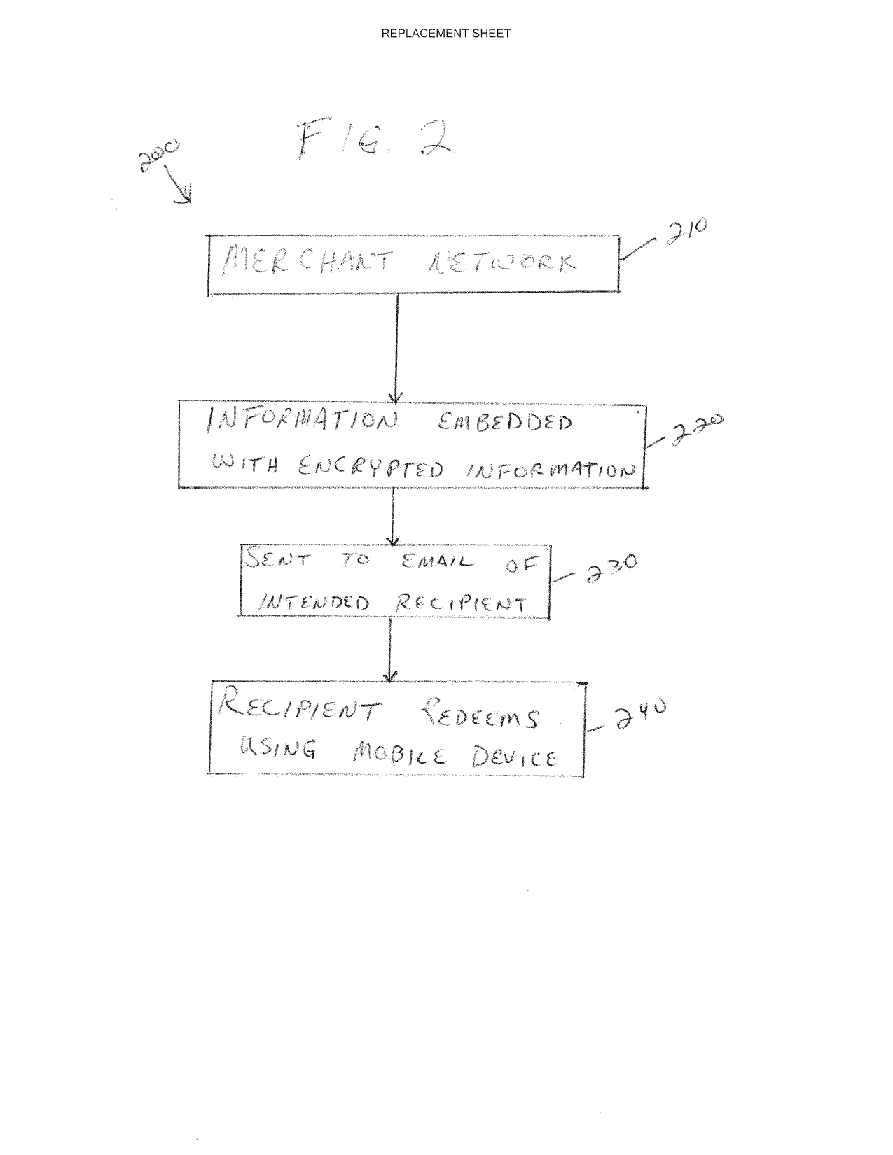

FIG. 2 provides flowchart 200 of an example embodiment of a method of electronic redemption using a mobile device. In block 210, a merchant network is accessed. In block 220, purchase information is embedded with encrypted information. In block 230, the encrypted information is sent to the email account of the intended recipient. In block 240, the recipient redeems the purchase using a mobile device.

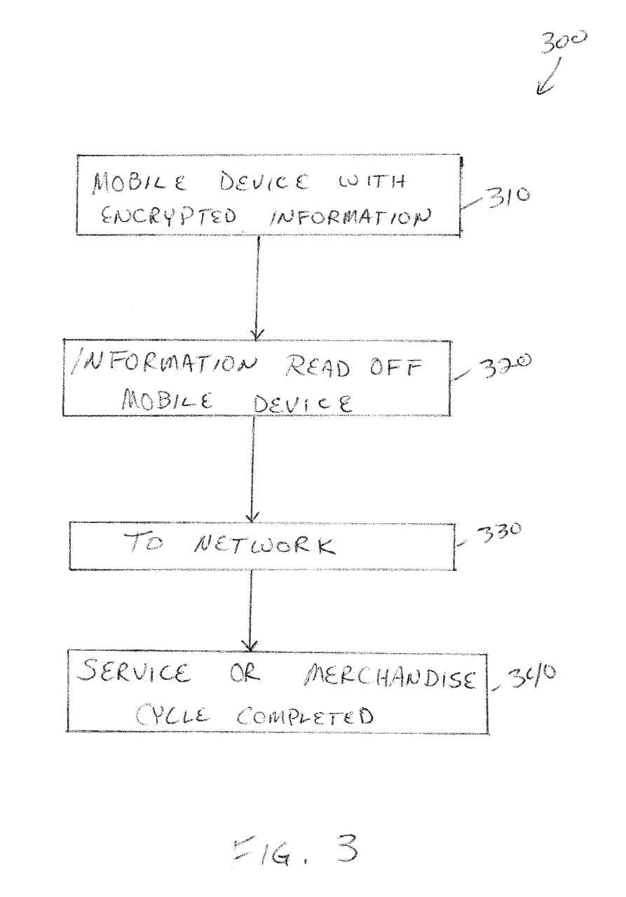

FIG. 3 provides flowchart 300 of an example embodiment of a method of electronic redemption using a mobile device. In block 310, a mobile device contains encrypted information of a purchase of a service or merchandise. In block 320, the information is read off of the mobile device. In block 330, the information is sent to the network. In block 340, the service or merchandise cycle is completed.

FIG. 4 provides flowchart 400 of an example embodiment of a method of electronic redemption using a mobile device. In block 410, a universal product code is sent to a mobile device. In block 420, the face of the mobile device is scanned or read. In block 430, the transaction is completed.

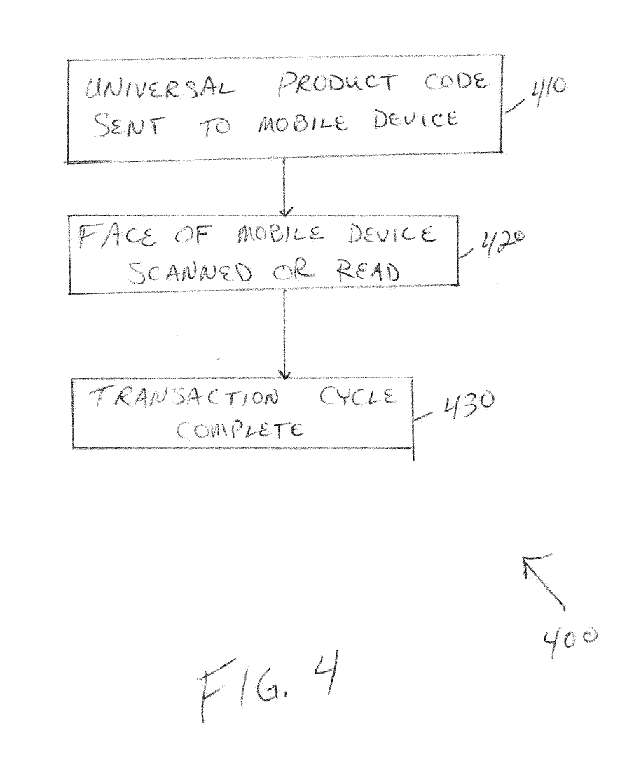

FIG. 5 provides flowchart 500 of an example embodiment of a method of electronic redemption using a mobile device. In block 510, a user uses a mobile device. In block 520, the user manipulates the mobile device in order for information to be read off of the mobile device.

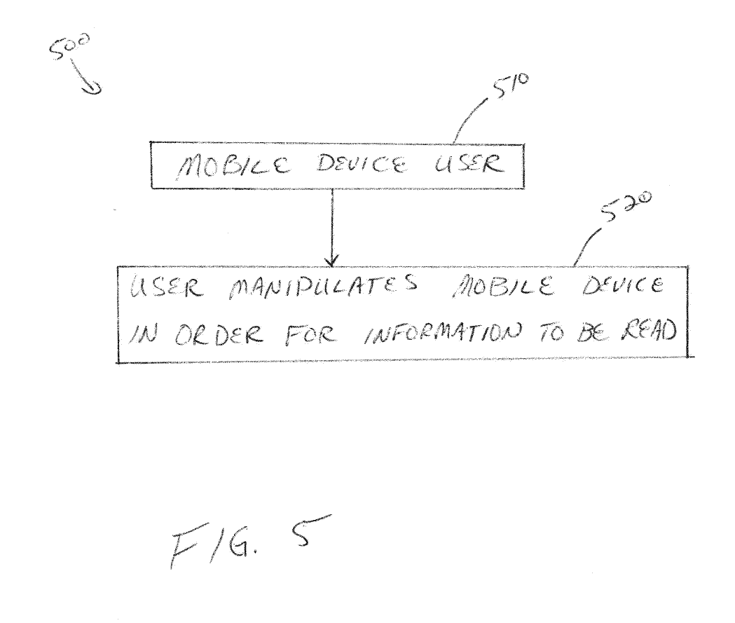

FIG. 6 provides flowchart 600 of an example embodiment of a method of electronic redemption using a mobile device. In block 610, a mobile device is used by a user. In block 620, the user approaches a physical point of redemption. In block 630, the mobile device is presented at a reading device at the physical point of redemption. In block 640, the user manipulates the mobile device on or around the reading device in order for the information displayed on the user device to be read. In block 650, the transaction is completed.

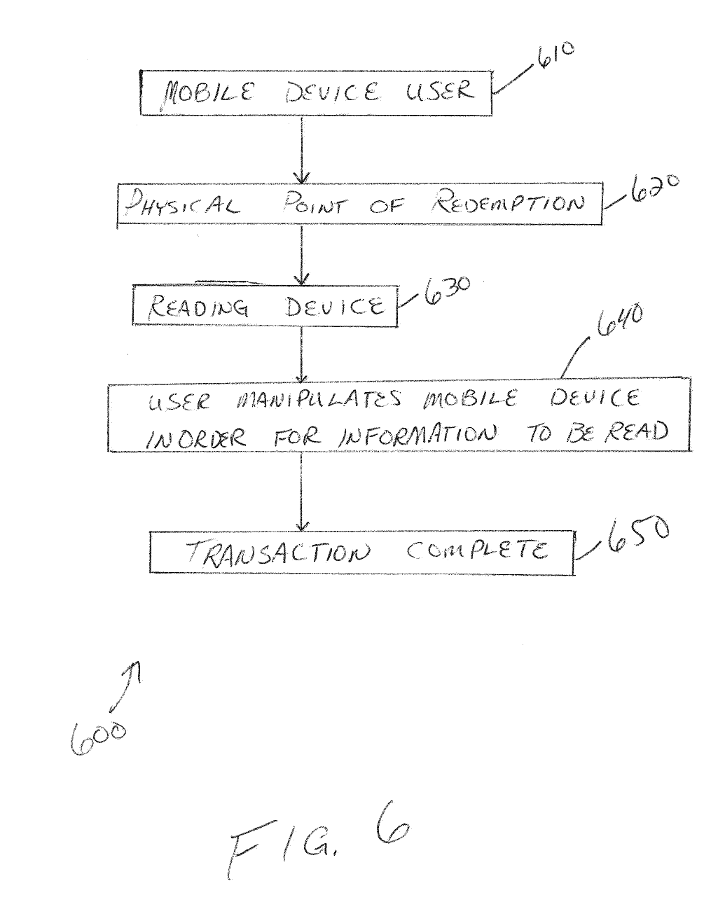

FIG. 7 provides system diagram 700 of an example embodiment of a system of electronic redemption using a mobile device, or a computerized redemption device. System 700 includes mobile device 710 and scanner 720. Mobile device 710 is positioned over scanner 720 such that the face of mobile device 710 is over the face of scanner 720.

FIG. 8 provides system diagram 800 of an example embodiment of a system of electronic redemption using a mobile device. System 800 includes UPC scanner 810 on top of RFID reader 820. In an example embodiment, information in the form of a bar code on mobile device 805 is presented to the reader. The information may be read by UPC scanner 810 or by RFID reader 820 if the information is presented in RFID format. The information may flow to the internet from either UPC scanner 810 or RFID reader 820. In an example embodiment, a keypad may be used for PIN entry. A red/green light may be used for notification purposes.

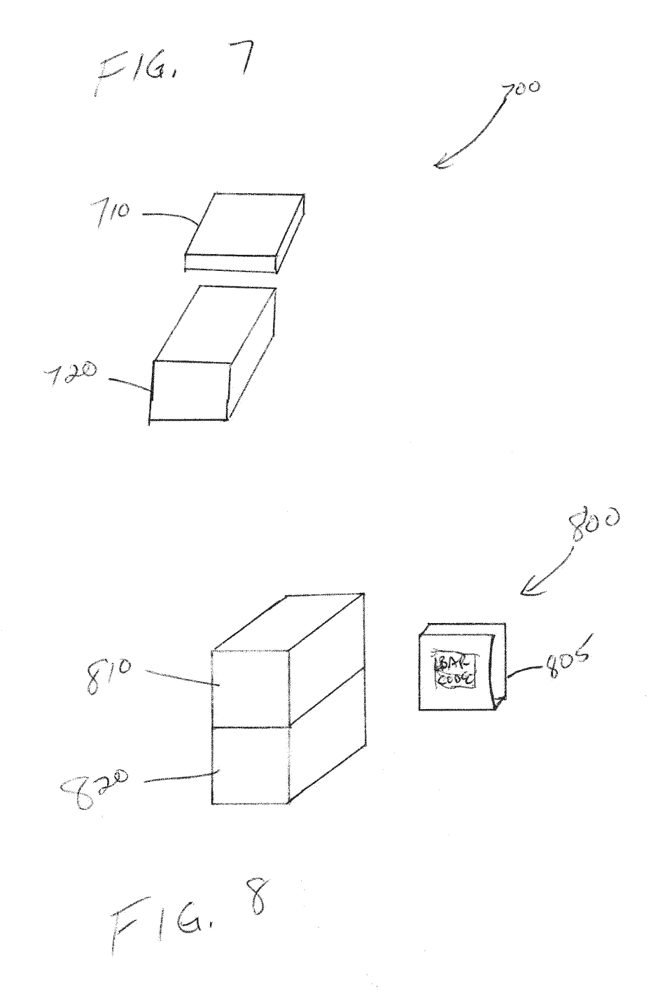

FIG. 9 provides system diagram 900 of an example embodiment of a system of electronic redemption using a mobile device. System 900 provides door 910 of an establishment using a reader. In an example embodiment, the reader scans the mobile device at door 910. Alternatively, the mobile device may be scanned by reader 930 on counter 920. An employee may perform a key/lock redemption process. In an example embodiment, the recipient may scan the UPC or RFID device at the door to the establishment and it is triggered electronically to the counter.

In example embodiments, a UPC code may be scanned at the point of redemption. The UPC may be scanned from a recipient print out, through a cell phone app, such as on an iPhone, or through an email message on a smart phone. The system may be used for paperless boarding of passengers.

Alternatively, an RFID device, such as one sent to a potential customer may be read and/or swiped. The RFID device may be sent to a potential customer for recharging at a participating establishment or a kiosk. The device may also be a CTA card-like device.

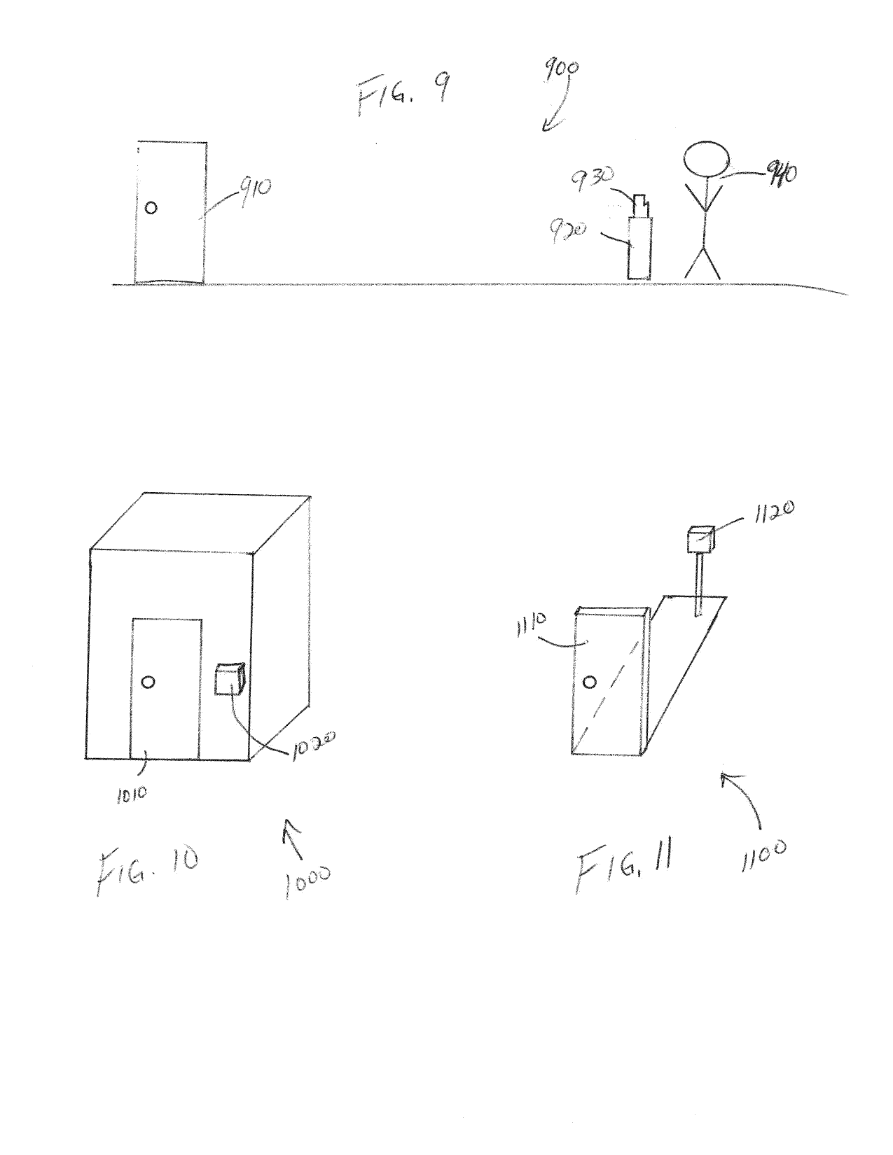

FIG. 10 provides system diagram 1000 of an example embodiment of a system of electronic redemption using a mobile device. System 1000 includes door 1010 and reader 1020. In an example embodiment, door 1010 is at the entry of a store. Reader 1020, for example, may be mounted on the entry wall. In an example embodiment, reader 1020 is a UPC or RFID reader as non-limiting examples.

FIG. 11 provides system diagram 1100 of an example embodiment of a system of electronic redemption using a mobile device. System 1100 includes door 1110 and reader 1120. In an example embodiment, door 1110 is at the entry of a store. Reader 1120, for example, may be pedestal mounted inside or outside of door 1110. In an example embodiment, reader 1120 is a UPC or RFID reader as non-limiting examples

I claim:

1. (canceled)

2. (canceled)

3. (canceled)

4. (canceled)

5. (canceled)

6. A method comprising:
receiving information regarding a purchase of a service or merchandise;
embedding the information on a wireless device; and
presenting the information to receive the service or merchandise from the purchase at a merchant.

7. The method of claim 6, wherein the information embedded on the mobile device is encrypted.

8. The method of claim 6, wherein the information is received through email.

9. The method of claim 6, wherein the information is presented by means of a bar code.

10. The method of claim 6, wherein the information is presented with an RFID device.

11. The method of claim 6, wherein the presenting occurs at an entrance door to the merchant.

12. The method of claim 6, wherein the presenting occurs at a counter of the merchant.

13. A system of redemption, comprising:
a device configured for receiving information regarding a purchase of a service or merchandise from the face of a wireless device;
a network interface connected to the device, the interface configured to send and receive verification information regarding the purchase information to determine the status of the transaction; and
an indicator configured to notify a merchant of the status of the transaction.

14. The system of claim 13, wherein the information is encrypted.

15. The system of claim 13, wherein the information is presented as a barcode on the face of the wireless device.

16. The system of claim 13, further comprising a device configured to send the information regarding the purchase of the service of the service or merchandise to the mobile device for presentation for redemption at the merchant.

17. The system of claim 13, wherein the purchase comprises a purchase of an airline ticket and the device is used for the paperless boarding of passengers.

18. The system of claim 13, wherein the device comprises at least one of a barcode reader and an RFID reader.

19. A method comprising:
receiving from a purchaser a request for a purchase of a service or merchandise;
sending purchase information to a customer indicated in the purchase;
receiving the purchase information from the customer through a wireless device;
verifying the purchase information; and
performing the service or presenting the merchandise to the customer.

20. The method of claim 19, wherein the purchase information is presented by means of a barcode.

21. The method of claim 19, wherein the purchase information sent to the customer is encrypted.

22. The method of claim 19, wherein the purchase information received from the customer is encrypted.

23. The method of claim 19, wherein the customer is the purchaser.

24. The method of claim 19, wherein the purchase is an airline ticket.

25. The method of claim 19, wherein the wireless device is a mobile phone.
